(19) United States
(12) Patent Application Publication
(10) Pub. No.: US 2021/0314477 A1
(43) Pub. Date: Oct. 7, 2021

(54) EXPOSURE CONTROL OF CAPTURED IMAGES

(71) Applicant: HEWLETT-PACKARD DEVELOPMENT COMPANY, L.P., Spring, TX (US)

(72) Inventors: Madhu Sudan Athreya, Palo Alto, CA (US); Will Allen, Corvallis, OR (US)

(73) Assignee: HEWLETT-PACKARD DEVELOPMENT COMPANY, L.P., Spring, TX (US)

(21) Appl. No.: 17/266,969

(22) PCT Filed: Aug. 17, 2018
(86) PCT No.: PCT/US2018/046943

§ 371 Date: Feb. 8, 2021

(51) Int. Cl. H04N 5/235; G01S 17/87; G01S 17/46

(52) U.S. Cl. CPC H04N 5/2354; G01S 17/46; G01S 17/87; H04N 5/2351

(57) ABSTRACT

A system for exposure control of captured images includes a processor, a memory device communicatively coupled to the processor, a first image capture device located within a space and communicatively coupled to the processor, a second image capture device located within the space and communicatively coupled to the processor, a plurality of electromagnetic wave sources located within the space, and an illumination module stored on the memory device and executable by the processor. the illumination module activates the first image capture device to capture an image of a subject, and coordinate the plurality of electromagnetic wave sources to illuminate the subject based on the location of the first image capture device relative to the subject and the location and an orientation of each of the electromagnetic wave sources.

### BACKGROUND

In many settings and environments, camera systems such as closed-circuit television (CCTV), video surveillance and other systems are used to capture images of an area. These images may be video images or still images, and data of the captured images may be stored and/or presented on a display device for later viewing. Areas that may benefit from the added security provided by these camera systems and their monitoring capabilities may include, for example, homes, banks, stores, office spaces, video conferencing rooms, warehouses, factory floors, and other areas where security or safety risks may exist.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a system for exposure control of captured images, according to an example of the principles described herein.

FIG. 2 is a block diagram of a system for exposure control of captured images, according to an example of the principles described herein.

FIG. 3 is a diagram of a surveillance environment including a depiction of the coordinates of the image capture devices and the optical angles of the image capture devices, according to an example of the principles described herein.

FIG. 4 is a diagram of a surveillance environment including a depiction of distance and angles calculations of the image capture devices and light sources relative to the subject, according to an example of the principles described herein.

FIG. 5 is a diagram of a surveillance environment including a depiction of distance and angles calculations of the image capture devices and light sources relative to the subject, according to an example of the principles described herein.

FIG. 6 is a diagram of a surveillance environment including a depiction of the illumination of the light sources of the image capture devices, according to an example of the principles described herein.

FIG. 7 is a block diagram of an auto exposure system of a surveillance environment, according to an example of the principles described herein.

FIG. 8 is a flowchart showing a method of controlling exposure of captured images, according to an example of the principles described herein.

FIG. 9 is a flowchart showing a method of controlling exposure of captured images, according to an example of the principles described herein.

FIG. 10 is a diagram of Lambertian radiation for an electromagnetic wave source, according to an example of the principles described herein.

FIG. 11 is a diagram of Lambertian radiation for an electromagnetic wave source at distance “d” and direction “θ, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Camera systems used to capture images of an area in order to, for example, increase security to individuals or property may suffer from a lack of proper lighting or illumination such that a subject such as an individual captured by the camera system may not be properly exposed by ambient or provided lighting systems. This may create a scenario where the images do not accurately or sufficiently capture the subject such that the subject may be recognized.

In some camera systems, a plurality of image capture devices may be mounted around a perimeter of the area of which images are to be captured. Additional lighting sources may be provided to illuminate the area if the ambient light is insufficient to expose the subject. Some of these lighting sources may be integrated into the image capture devices themselves or may be stand-alone illumination devices. The light provided by the lighting sources may not expose the subject appropriately due to the angles of the lighting sources which may not be directed at the subject. Further, the activation of too few or too many lighting sources may result in under-exposure of the subject or over-exposure of the subject, respectively. Still further, in some lighting systems that accompany the camera systems, the lighting sources may all turn on at once without consideration as to where in the area the subject is located resulting in instances of under-exposure or over-exposure of the subject as the subject moves throughout the area.

In some camera surveillance scenarios, there exists a trend to increase the number of image capture devices within a given area. For example, an office room within a factory premises might include several image capture devices, and a plurality of image capture devices may be used in video conferencing rooms. The outputs from the camera feeds provided by the multiple image capture devices may be fed to back end computer vision or deep learning systems to recognize persons, objects, scenes, and activities. These machine learning systems and methods are based on learning data representations, as opposed to task-specific logic, and may be helpful in identifying the subject being surveilled.

However, in these camera systems, illumination may be challenging in capturing proper videos and consequently in accomplishing the computer vision tasks with a high degree of success. To overcome the illumination challenges, a light emitting diode (LED) may accompany a number of the image capture devices in the camera system. However, an LED is a weak illuminant. While xenon lamps are a superior illuminant source, it is not appropriate for video applications. LED light sources are useful in a single camera scenario when the subjects are in close proximity to the image capture device and the light provided by the LED. However, this may not be the case in a conference room or a warehouse setting. The distance between the image capture device and the subject may be ten to twenty feet or more. While this distance is challenging, higher resolution and computational photography techniques may overcome this challenge. However, the illumination issue remains unsolved. LEDs designed for the form factor and cost constraints of a security or conference room camera provide illumination, but the luminance of the LED sources, over a given distance to a subject, with a given sensitivity and response function on a sensor, may not provide sufficient radiant energy (i.e., lux, or radiant energy incident upon) onto the subject.

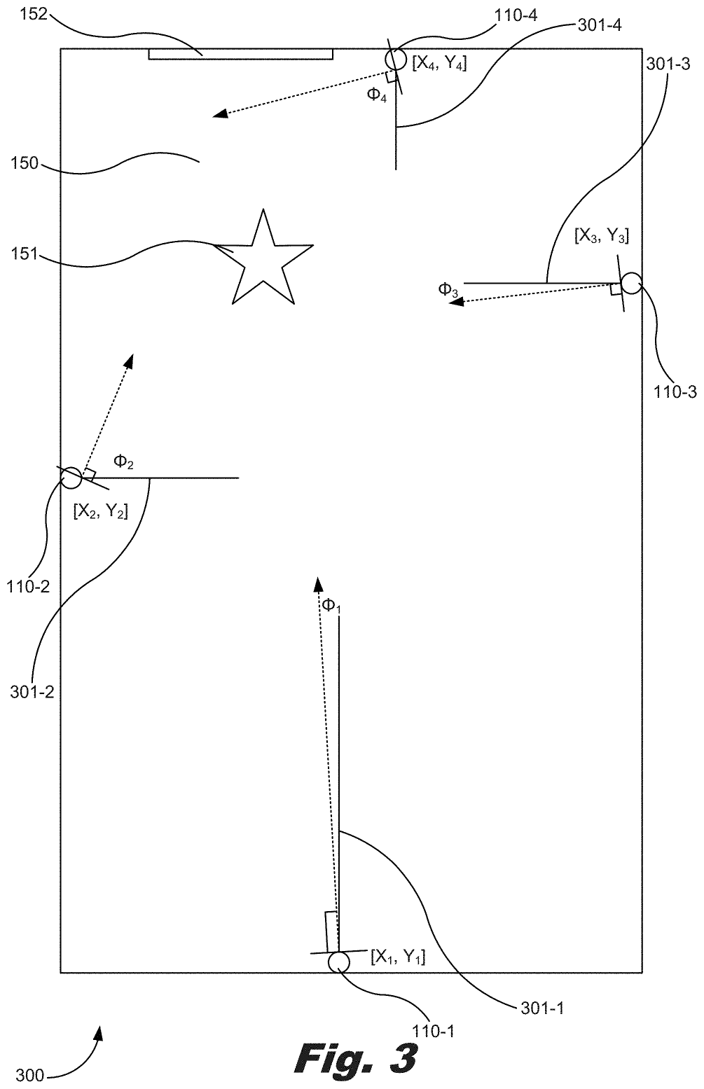

For example, with reference to FIG. 3, four image capture devices (110-1, 110-2, 110-3, 110-4, collectively referred to herein as 110) with integrated LEDs may be mounted within an area. If an individual (151) represented by the star, for example, were to enter the room (150) through an entrance (152), the first image capture device (110-1) may have the best frontal view of the individual (151) and hence has the higher probability of making an accurate recognition of the individual (151). The second image capture device (110-2) and third image capture device (110-3) may both have a side view of the individual (151), and the fourth image capture device (110-4) has a back view of the individual (151). However, as depicted in the example of FIG. 3, the first image capture device (110-1) may be furthest from the individual (151). As a result, the LED integrated into the first image capture device (110-1) may be a poor illuminant source given the distance from the individual (151).

Examples described herein provide a system for exposure control of captured images. The system includes a processor, a memory device communicatively coupled to the processor, a first image capture device located within a space and communicatively coupled to the processor, a second image capture device located within the space and communicatively coupled to the processor, a plurality of electromagnetic wave sources located within the space, and an illumination module stored on the memory device and executable by the processor. The illumination module may, when executed by the processor activate the first image capture device to capture an image of a subject, and coordinate the plurality of electromagnetic wave sources to illuminate the subject based on the location of the first image capture device relative to the subject and the location and an orientation of each of the electromagnetic wave sources as well as other electromagnetic wave sources that may be present within the space.

The illumination module activates the plurality of electromagnetic wave sources differently in response to detection of the subject moving within the space. The illumination module activates a second image capture device of the plurality of image capture devices in response to detection of the subject moving within the space. Each of the image capturing devices are paired with one of the electromagnetic wave sources such that each image capturing device and electromagnetic wave source are integrated as the same device.

Examples described herein also provide a method of controlling exposure of captured images. The method may include determining the capabilities of each of a plurality of electromagnetic wave sources located within a space, determining coordinates within the space at which a plurality of image capture devices are located, and determining positions of the electromagnetic wave sources and image capture devices relative to a subject based on detected coordinates of the subject. Determining positions of the electromagnetic wave sources and image capture devices relative to a subject based on detected coordinates of the subject includes determining distances between the electromagnetic wave sources, the image capture devices, and the subject, and determining an orientation of each of the electromagnetic wave sources and each of the image capture devices relative to the subject. The method may also include determining a radiant energy value from the plurality of electromagnetic wave sources for illumination of the subject, and illuminating the subject for image capture by the plurality of image capture devices based on a real-time auto exposure value as the subject moves within the space.

Determining relative distances between the subject and each of the electromagnetic wave sources includes determining an angle of the subject with respect to each surface normal of each electromagnetic wave source. The method includes synchronizing communications between the image capture devices. Determining the radiant energy value includes calculating a plurality of irradiance curves, and storing the plurality of irradiance curves in a look up table. The method includes triggering the plurality of electromagnetic wave sources. The radiant energy value from the plurality of electromagnetic wave sources is based on an angle of illumination of each of the plurality of electromagnetic wave sources.

Examples described herein also provide a computer program product for controlling exposure of captured images. The computer program product includes a computer readable storage medium including computer usable program code embodied therewith. The computer usable program code, when executed by a processor determines the capabilities of each of a plurality of electromagnetic wave sources located within a space, and determines coordinates within the space at which a plurality of image capture devices are located. The computer usable program code synchronizes communications between the image capture devices, determines positions of the electromagnetic wave sources and image capture devices relative to a subject based on detected coordinates of the subject, and determines a radiant energy value from the plurality of electromagnetic wave sources for illumination of the subject based on an angle of illumination of each of the plurality of electromagnetic wave sources. The computer usable program code illuminates the subject for image capture by the plurality of image capture devices based on a real-time auto exposure value as the subject moves within the space.

Determining positions of the electromagnetic wave sources and image capture devices relative to a subject based on detected coordinates of the subject includes determining distances between the electromagnetic wave sources, the image capture devices, and the subject, determines an orientation of each of the electromagnetic wave sources and each of the image capture devices relative to the subject, and determines relative distances between the subject and each of the electromagnetic wave sources comprises determining an angle of the subject with respect to each surface normal of each electromagnetic wave source.

The computer program product includes computer usable program code to, when executed by a processor, activate the electromagnetic wave sources differently in response to detection of the subject moving within the space. Determining the radiant energy value may include calculating a plurality of range of irradiance curves, and storing the plurality of range of irradiance curves in a look up table. The computer program product includes computer usable program code to, when executed by a processor, trigger the plurality of electromagnetic wave sources to obtain an auto exposure of the subject using an auto-exposure system.

As used in the present specification and in the appended claims, the terms “radiant energy,” “lumens,” “lux,” “illuminance”, and “luminance” are meant to be understood broadly as any radiant energy provided by an electromagnetic wave source and the manner in which that radiant energy may be measured. In the examples described herein, infrared wavelengths of radiant energy and visible wavelengths of radiant energy may be used in connection with the present systems and methods. However, any wavelength of electromagnetic waves may be used whether inside or outside the visible spectrum.

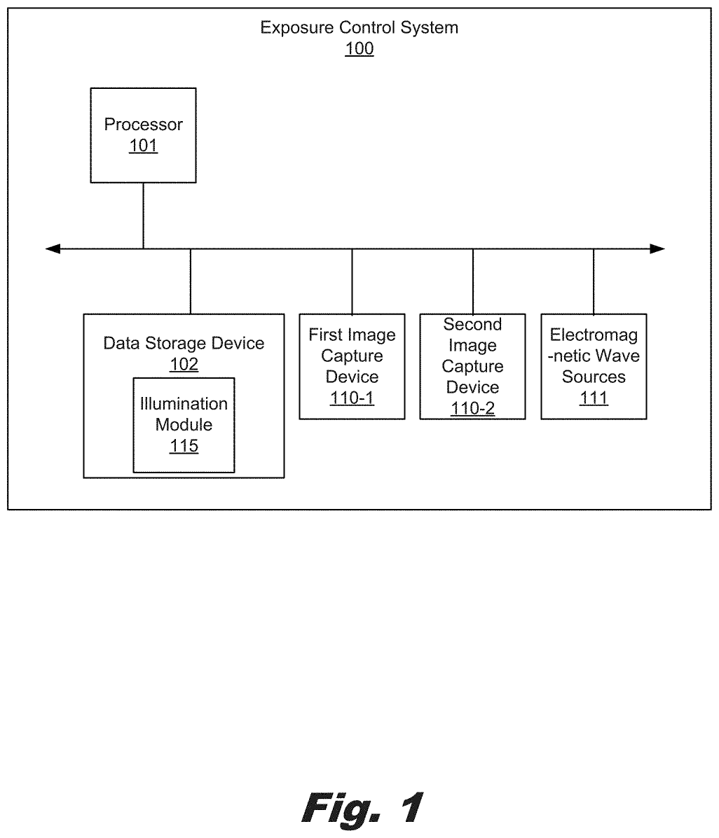

Turning now to the figures, FIG. 1 is a block diagram of a system (100) for exposure control of captured images, according to an example of the principles described herein. The exposure control system (100) may be implemented in any scenario in which the it is desired that an area be monitored or surveilled by a number of image capture devices, and may include a processor (101) and a data storage device (102) communicatively coupled to the processor (101).

The system (100) may also include a first image capture device (110-1) positioned relative to at least a second image capture device (101-2) located within a space (150) and communicatively coupled to the processor (101). The system (100) may include a plurality of image capture devices (110) used to image a subject within the space (150) from a plurality of angles and distances. In one example, the first image capture device (101-1) may act as a master or primary image capture device that has unidirectional control over other slave or replica image capture devices and/or other devices such as the electromagnetic wave sources described herein. The image capture devices (101) described herein may include optics through which light may enter, and an image recording device such as a charge-coupled device (CCD), a complimentary metal-oxide semiconductors (CMOS), or other image recording devices. The image capture devices (101) described herein may also include sensors to detect the existence of photons of light in the space (150). These light sensors may be photodetectors. In one example, the photodetectors may also be able to detect the movement of objects within the space (150) being monitored relative to that object's surroundings. In one example, the photodetectors may include infrared sensors, passive infrared (PIR) sensors or other types of sensors that may detect motion as well as electromagnetic waves.

The image capture devices (101) may be continually recording the space (150) in which they are deployed, may be activated when a trigger event such as the movement of an objection within the space occurs, may capture a plurality of still images of the space (150) over a period of time, and combinations thereof.

The system (100) may also include a plurality of electromagnetic wave sources (111) located within the space (150). In one example, the electromagnetic wave sources (111) may include light emitting diodes (LEDs), infrared LEDs, or other electromagnetic wave sources (111) capable of producing and emitting electromagnetic waves in the visible or non-visible wavelength spectrums. In one example, the first image capture device (110-1), acting as the primary image capture device, may have unidirectional control over the electromagnetic wave sources (111). Thus, the electromagnetic wave sources (111) may emit infrared electromagnetic waves where IR LEDs and IR-sensitive sensors are used, or may emit visible electromagnetic waves where, for example, red, green, blue (RGB) or white LEDs and RGB (visible light) cameras are used.

In one example, the image capture devices (110) and electromagnetic wave sources (111) may be integrated into single units where each image capture device (110) is integrated with an electromagnetic wave source (111). In this example, each combination of image capture device (110) and electromagnetic wave source (111) have an imaging angle and an illumination angle relative to a surface normal to a surface at which the combination of image capture device (110) and electromagnetic wave source (111) are coupled. Examples described herein will be described in connection with integrated image capture devices (110) and electromagnetic wave sources (111). However, in other examples, the image capture devices (110) and electromagnetic wave sources (111) may not be integrated devices, but may still operate in a similar manner as described herein.

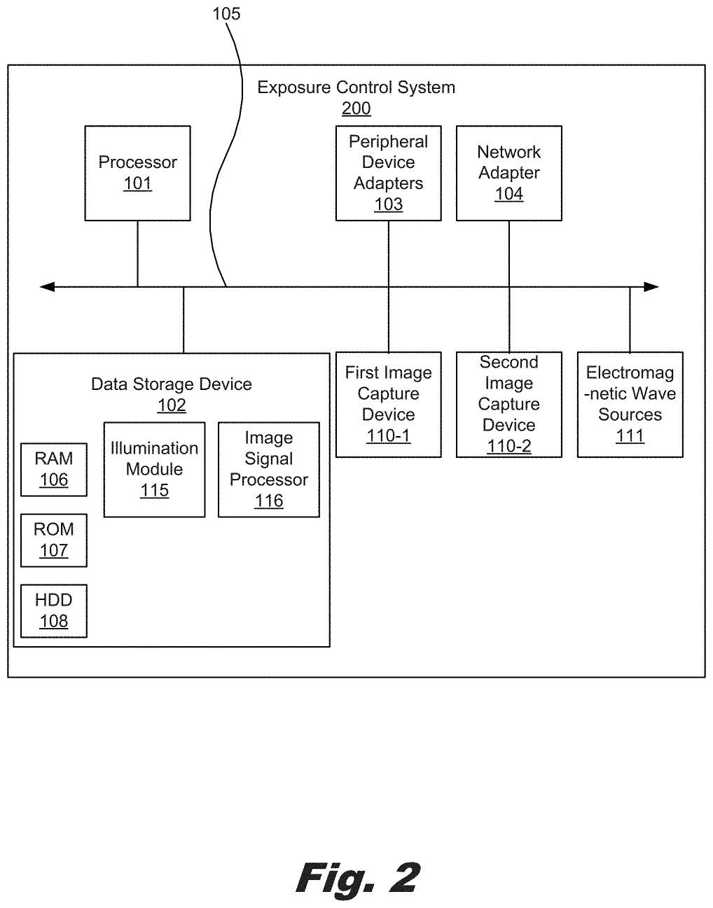

The system (100) may further include an illumination module (115) stored on the data storage device (102) and executable by the processor (101). The illumination module (115), when executed by the processor, activates the first image capture device of the plurality of image capture devices to capture an image of a subject, and coordinate the plurality of electromagnetic wave sources to illuminate the subject based on the location of the first image capture device relative to the subject and the location and an orientation of each of the electromagnetic wave sources. More details of the system of FIG. 1 will now be described in connection with FIG. 2.

FIG. 2 is a block diagram of a system (200) for exposure control of captured images, according to an example of the principles described herein. The system (200) may be implemented in an electronic device. Examples of electronic devices include servers, desktop computers, laptop computers, personal digital assistants (PDAs), mobile devices, smartphones, smart cameras, gaming systems, and tablets, among other electronic devices.

The system (200) may be utilized in any data processing scenario including, stand-alone hardware, mobile applications, through a computing network, or combinations thereof. Further, the system (200) may be used in a computing network, a public cloud network, a private cloud network, a hybrid cloud network, other forms of networks, or combinations thereof. In one example, the methods provided by the system (200) may be provided as a service over a network by, for example, a third party. In this example, the service may include, for example, the following: a Software as a Service (SaaS) hosting a number of applications; a Platform as a Service (PaaS) hosting a computing platform including, for example, operating systems, hardware, and storage, among others; an Infrastructure as a Service (IaaS) hosting equipment such as, for example, servers, storage components, network, and components, among others; application program interface (API) as a service (APIaaS), other forms of network services, or combinations thereof. The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the system (200) may be executed by a local administrator.

To achieve its desired functionality, the system (200) includes various hardware components. Among these hardware components may be a number of processors (101), a number of data storage devices (102), a number of peripheral device adapters (103), a number of network adapters (104) a plurality of image capture devices (110), and a plurality of electromagnetic wave sources (111). These hardware components may be interconnected through the use of a number of busses and/or network connections such as bus (105).

The processor (101) may include the hardware architecture to retrieve executable code from the data storage device (102) and execute the executable code. The executable code may, when executed by the processor (101), cause the processor (101) to implement at least the functionality of determining the capabilities of each of a plurality of electromagnetic wave sources located within a space (150), determining coordinates within the space (150) at which a plurality of image capture devices are located, and determining positions of the electromagnetic wave sources and image capture devices relative to a subject based on detected coordinates of the subject. Determining positions of the electromagnetic wave sources and image capture devices relative to a subject based on detected coordinates of the subject may include determining distances between the electromagnetic wave sources, the image capture devices, and the subject and determining an orientation of each of the electromagnetic wave sources and each of the image capture devices relative to the subject. Further, the executable code may, when executed by the processor (101), may cause the processor (101) to implement at least the functionality of determining a luminance value or radiant energy value from the plurality of electromagnetic wave sources for illumination of the subject, and illuminating the subject for image capture by the plurality of image capture devices based on a real-time auto exposure value as the subject moves within the space (150). Thus, the processor (101) may function according to the methods of the present specification described herein. In the course of executing code, the processor (101) may receive input from and provide output to a number of the remaining hardware units.

The data storage device (102) may store data such as executable program code that is executed by the processor (101) or other processing device. As will be discussed, the data storage device (102) may specifically store computer code representing a number of applications that the processor (101) executes to implement at least the functionality described herein. The data storage device (102) may include various types of memory modules, including volatile and nonvolatile memory. For example, the data storage device (102) of the present example includes Random Access Memory (RAM) (106), Read Only Memory (ROM) (107), and Hard Disk Drive (HDD) memory (108). Many other types of memory may also be utilized, and the present specification contemplates the use of many varying type(s) of memory in the data storage device (102) as may suit a particular application of the principles described herein. In certain examples, different types of memory in the data storage device (102) may be used for different data storage needs. For example, in certain examples the processor (101) may boot from Read Only Memory (ROM) (107), maintain nonvolatile storage in the Hard Disk Drive (HDD) memory (108), and execute program code stored in Random Access Memory (RAM) (106).

The data storage device (102) may include a computer readable medium, a computer readable storage medium, or a non-transitory computer readable medium, among others. For example, the data storage device (102) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters (103, 104) in the system (200) enable the processor (101) to interface with various other hardware elements, external and internal to the system (200). For example, the peripheral device adapters (103) may provide an interface to input/output devices, such as, for example, the image capture devices (110), the electromagnetic wave sources (111), a display device, a mouse, or a keyboard. The peripheral device adapters (103) may also provide access to other external devices such as an external storage device, a number of network devices such as, for example, servers, switches, and routers, client devices, other types of computing devices, and combinations thereof.

The system (200) further includes a number of modules used in the implementation according to the methods of the present specification described herein. The various modules within the system (200) include executable program code that may be executed separately. In this example, the various modules may be stored as separate computer program products. In another example, the various modules within the system (200) may be combined within a number of computer program products; each computer program product including a number of the modules.

The system (200) may include an illumination module (115) to, when executed by the processor (101), causes the system (200) to execute the functions of the processor (101). The illumination module (115) causes the illumination capabilities of a plurality of electromagnetic wave sources (111) within the same space (150) to be used in concert in order to provide an appropriate level of exposure for the subject that the image capture devices (110) are capturing images of. FIG. 3 is a diagram of a surveillance environment (300) including a depiction of the coordinates of the image capture devices (110) and the optical angles of the image capture devices (110), according to an example of the principles described herein. In FIG. 3, the image capture devices (110-1, 110-2, 110-3) may be integrated image capture devices (110) and electromagnetic wave sources (111). In this example, the image capture devices (110-1, 110-2, 110-3) are closer and their integrated electromagnetic wave sources (111) may better illuminate the subject (151). Additionally, instead of relying on one weak illuminant such as the electromagnetic wave source integrated into image capture devices (110-1), or one of the stronger electromagnetic wave sources (111) such as the electromagnetic wave sources integrated into image capture devices (110-2, 110-3), it may prove beneficial to illuminate the subject (151) when all three stronger electromagnetic wave source integrated into image capture devices (110-2, 110-3, 110-4), along with the relatively weaker electromagnetic wave source integrated into image capture devices (110-1), are used to simultaneously to illuminate the subject (151). In this example, the electromagnetic wave source integrated into image capture device (110-4) may not be used because the light provided by the electromagnetic wave source integrated into image capture device (110-4) is a backlight source relative to image capture device (110-1) which may not provide an increase in illumination of the subject (151) and may cause images captured by the image capture device (110-4) to be overexposed. In this manner, the illumination module (115) activates the electromagnetic wave sources (111) integrated into image capture devices (110) to assist in providing better exposure of the subject (151) while also allowing for recording images or videos that are more uniformly illuminated.

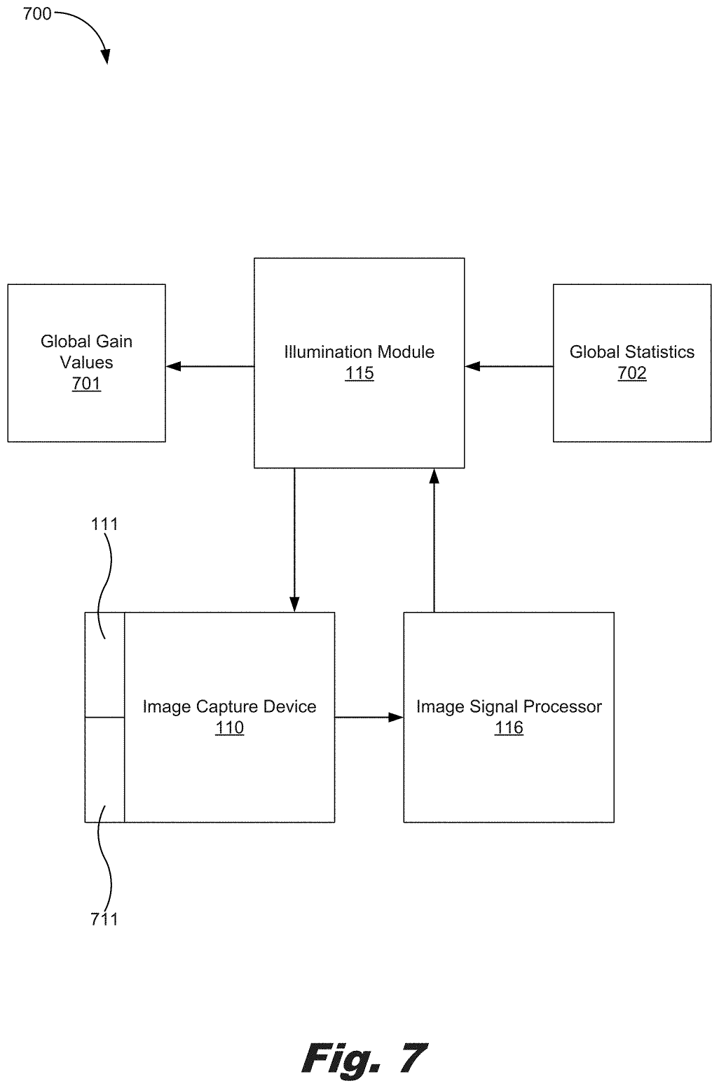

The system (200) may include an image signal processor (ISP) (116) to, when executed by the processor (101), process images captured by the image capture devices (110). Captured images are processed by the ISP (116) as sensors (FIG. 7, 711) included with the image capture devices (110) meter the subject illumination by processing incoming frames of the captured images and extract statistics relating to the illumination of the subject. As photons are incident upon the sensors (FIG. 7, 711), the sensors (FIG. 7, 711) integrate all the pixels. When the entire pixel array is read, the processor (101) forms a raw image frame which may be sent to the ISP (116) for processing. The values obtained from the ISP (116) may define values regarding sensor gain of the sensors (FIG. 7, 711), integration time, and electromagnetic wave sources (111) (e.g., LED) amplitude settings. The frame from the resulting exposure is then read. The ISP (116) of the system (200) considers the illuminate values from a plurality of the electromagnetic wave sources (111) and controls the amplitude of the other electromagnetic wave sources (111). In effect all electromagnetic wave sources (111) function as a single virtual light source, and the auto-exposure methods read frames and meter the exposure value as captured by the image capture devices (110) until an optimum exposure is reached.

The processor (101) may identify and register the capabilities of each of the image capture devices (110) and electromagnetic wave sources (111). Capabilities of the image capture devices (110) may include, for example, the image capture resolution of the image capture devices (110), the frame capture rate of image capture devices (110), the optics parameters of the image capture devices (110), the focal length of the image capture devices (110), other capabilities of the image capture devices (110), and combinations thereof. Capabilities of the electromagnetic wave sources (111) may include, for example, the wavelengths of the electromagnetic wave sources (111), the radiant energy, the luminous flux, luminous intensity, luminance, illuminance, and/or luminous energy density of the electromagnetic wave sources (111), other capabilities of the electromagnetic wave sources (111), and combinations thereof. In one example, the processor (101) may determine the capabilities of the image capture devices (110) and electromagnetic wave sources (111) when the system (200) is installed, when the system (200) is activated, when at least one of the image capture devices (110) and/or electromagnetic wave sources (111) is activated, or at any other time. The capabilities of the image capture devices (110) and electromagnetic wave sources (111) may be obtained as the image capture devices (110) and electromagnetic wave sources (111) communicate with the processor (101). The capabilities of the image capture devices (110) and electromagnetic wave sources (111) may be stored in the data storage device (102). Further, any image capture device (110) with an electromagnetic wave source (111) may broadcast its intent to register to all other image capture devices (110) and electromagnetic wave sources (111). Once the image capture devices (110) and electromagnetic wave sources (111) are all registered, the image capture devices (110) and electromagnetic wave sources (111) may self-advertise their capabilities. In this manner, each image capture devices (110) and electromagnetic wave sources (111) is aware of other image capture devices (110) and electromagnetic wave sources (111) within the space (150) and their respective capabilities.

The processor (101) may also determine and record in the data storage device (102) the coordinates of the image capture devices (110) and electromagnetic wave sources (111). Referring again to FIG. 3, the first image capture device (110-1) is located at (X₁, Y₁), the second image capture device (110-2) is located at (X₂, Y₂), the third image capture device (110-3) is located at (X₃, Y₃), and the fourth image capture device (110-4) is located at (X₄, Y₄). Further, the processor (101) may also determine and record in the data storage device (102) the optical angles, ϕ₁, ϕ₂, ϕ₃, ϕ₄ for the respective image capture devices (110) and electromagnetic wave sources (111). The optical angles are formed by the respective surface normal (301-1, 301-2, 301-3, 301-4, collectively referred to herein as 301) for each of the electromagnetic wave sources (111) whether the electromagnetic wave sources (111) are integrated with the image capture devices (110) or are standalone electromagnetic wave sources (111). The surface normals (301) of the electromagnetic wave sources (111) are with respect to the walls of the space (150) on which the image capture devices (110) and electromagnetic wave sources (111) are mounted.

It is to be noted that in FIGS. 3-6, 10, and 11 dimensions in the z-direction are not displayed or indicated, and that all calculations are in two dimensions. However, these calculations extend to three dimensions, and geometric analysis may be performed in three-dimensions for all the distance and angle calculations.

The processor (101) also causes the image capture devices (110) and electromagnetic wave sources (111) to be able to message with one another and synchronize with one another. In one example, the image capture devices (110) and electromagnetic wave sources (111) may use any wired or wireless communication standards to communicate with one another. For example, the image capture devices (110) and electromagnetic wave sources (111) may utilize a wireless messaging scheme such as, for example, WiFi utilizing IEEE 802.11 standards. In this example, the wireless messaging scheme may be employed for each image capture devices (110) and electromagnetic wave sources (111) to read data values from other image capture devices (110) and electromagnetic wave sources (111), to send messages to another image capture devices (110) and electromagnetic wave sources (111), or broadcast messages to all image capture devices (110) and electromagnetic wave sources (111). In one example, a low latency communication protocol may be used for synchronization purposes between the image capture devices (110) and electromagnetic wave sources (111) in order to allow for the fastest possible data transfer between these devices.

The processor (101) may determine distances and direction of the of the subject (151) with respect to the image capture devices (110) and electromagnetic wave sources (111). In order to determine the relative distances and directions of the subject (151) with respect to each of image capture devices (110) and electromagnetic wave sources (111), the processor (101) may establish the coordinates of the subject (151). In one example, the relative distances and directions of the subject (151) with respect to each of image capture devices (110) and electromagnetic wave sources (111) may be accomplished the use of WiFi triangulation, three-dimensional (3D) cameras, laser scanning, manual measurement and entry into a digital table, or other processes or device. Once the relative distances and directions of the subject (151) with respect to each of image capture devices (110) and electromagnetic wave sources (111) are obtained, these values may be stored in the data storage device (102).

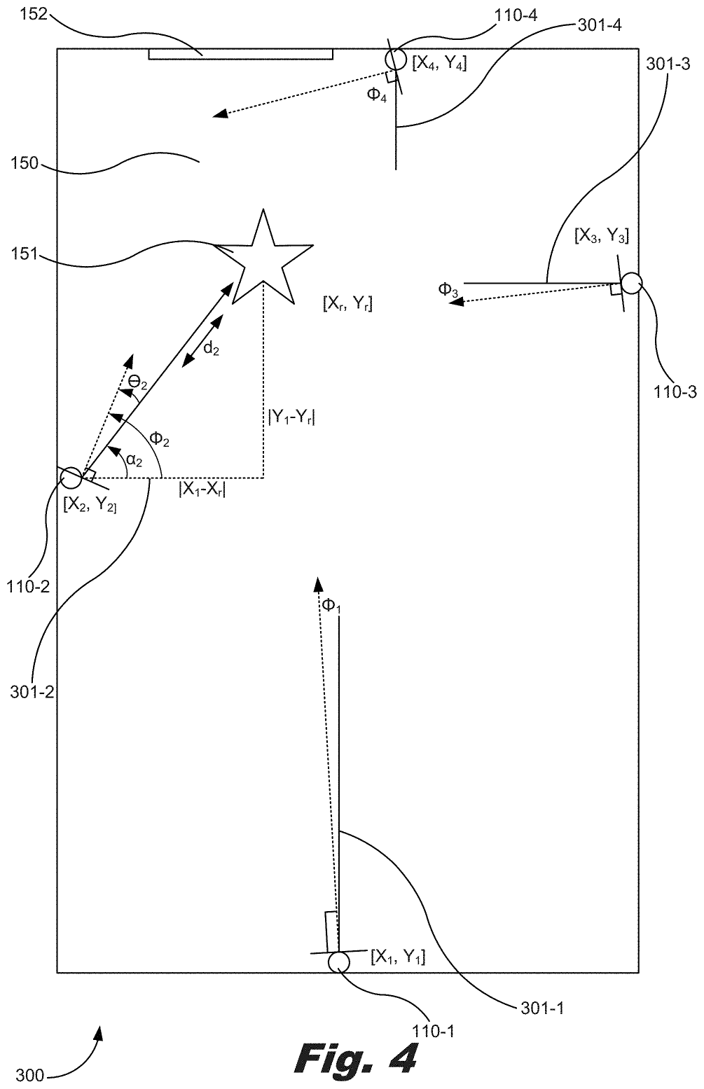

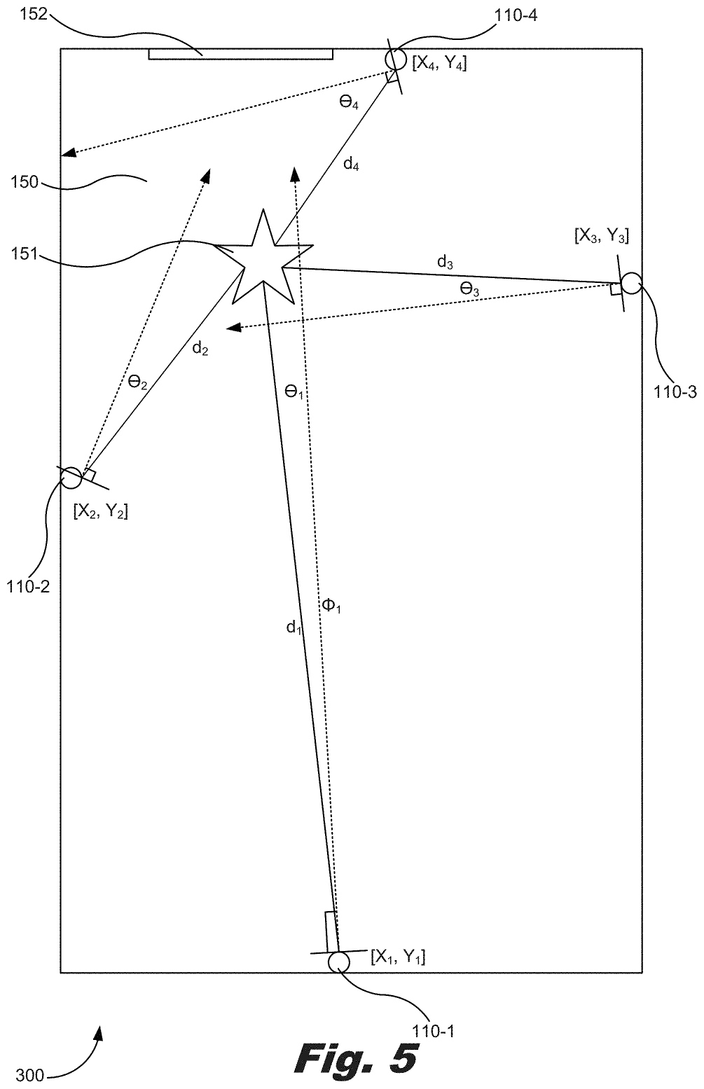

With use of the coordinates of the image capture devices (110) and electromagnetic wave sources (111) determined and stored in data storage device (102), the processor (101) determines the distance between the subject (151) and the image capture devices (110) and electromagnetic wave sources (111) through geometrical calculations. FIG. 4 is a diagram of a surveillance environment (300) including a depiction of distance and angles calculations of the image capture devices (110) and electromagnetic wave sources (111) relative to the subject (151), according to an example of the principles described herein. Further, FIG. 5 is a diagram of a surveillance environment (300) including a depiction of distance and angles calculations of the image capture devices (110) and electromagnetic wave sources (111) relative to the subject (151), according to an example of the principles described herein.

In FIGS. 4 and 5, distance d₁ may be calculated using, for example, geometric and trigonometric calculations. Similarly, it is possible to determine the angle with respect to the surface normal (301) for each image capture devices (110) and electromagnetic wave sources (111). For the second image capture devices (110-2) and its associated electromagnetic wave source (111) in instances where the image capture devices (110) and electromagnetic wave sources (111) are integrated with one another, it is possible calculate angle α₂ which is the angle between the surface normal (301-2) and a line that defines a straight line between the image capture devices (110) and electromagnetic wave sources (111) and the subject (151).

Since ϕ₂ has been determined when the processor (101) determined the optical angles formed by the respective surface normal (301-2) for the image capture devices (110) and electromagnetic wave sources (111), it is possible to further calculate θ₂, which is the angle of the subject (151) with respect to the surface normal (301-2) of the second image capture device (110-2) and its associated electromagnetic wave source (111). In the same manner d₁ and θ₂ are determined for the first image capture device (110-1) and its associated electromagnetic wave source (111), d₃ and θ₃ are determined for the third image capture device (110-3) and its associated electromagnetic wave source (111), and d₄ and θ₄ are determined for the third image capture device (110-3) and its associated electromagnetic wave source (111).

The processor (101), executing the illumination module (115), may estimate the illumination of the subject (151) at the image capture devices (110) and electromagnetic wave sources (111). In one example, the illumination of the subject (151) may be estimated by metering activation of the electromagnetic wave sources (111) associated with the image capture devices (110) previous to an activation of the system (200) when the subject (151) is present in a pre-flash manner.

In one example, the illumination of the subject (151) may be estimated by estimating the illumination based on the capabilities of the electromagnetic wave sources (111) in an electromagnetic wave source (111) model approach. In a system (200) that utilizes a plurality image capture devices (110), it may not be practical to use the pre-flash method of metering. Thus, the electromagnetic wave source (111) model approach may be taken. Even though the models may be applicable for a single electromagnetic wave source (111), a basic model may be used in order to minimize computational complexity and to ensure real-time processing. While this model may result in some approximations of the illumination values, the loss in accuracy is acceptable for the distributed illumination application described herein. A more sophisticated model may be employed without changing the outcome of the calculations or the function of the systems and methods described herein. This may include using a model based on actual measurements of the electromagnetic wave sources (111).

In this model approach, the system assumes the electromagnetic wave source (111) is a point source as this is a reasonable approximation considering the subject (151) is likely to be a far enough distance from the image capture devices (110) and the electromagnetic wave sources (111). Another assumption includes the assumption that the intensity of radiation of the electromagnetic wave sources (111) includes a roll-off with radial symmetry. Because a plot of intensity of radiation indicates that the intensity of the radiation drops off from a center point, this is reasonable approximation. Another approximation may include the assumption that the point of irradiance is uniform within the area surrounding it. At distances of three or more meters, and at a small enough subtending angle, the area will be small enough that uniform irradiance can be assumed.

The above assumptions are valid and a basic model is adequate to establish balance between real-time computing goals and accuracy in the actual values of illumination of the subject (151). Although these assumptions are made in order to increase real-time computing of the illumination values, the methods and systems described herein do not preclude the utilization of more advanced models in obtaining the illumination values. In the examples described herein, the electromagnetic wave sources (111) emit photons in a Lambertian pattern. However, in other examples, the electromagnetic wave sources (111) may also incorporate a lens which directs photons along a given path. In these examples, the radiation is not dispersed according to Lambert's emission law, but is dispersed instead according to the optical system. The patterns of dispersion may be known in advance such as being supplied by a manufacturer of the optics, or the patterns of dispersion may be measured. In this example, the patterns of dispersion do not change over time. Thus, in one example, in place of the Lambertian model, any other model of the pattern of dispersion of radiation from a source may be used in the present systems and methods.

As to radiation patterns of the electromagnetic wave sources (111), the radiation patterns may be approximated to that of a Lambertian light source. In optics, Lambert's cosine law says that the radiant intensity or luminous intensity observed from an ideal diffusely reflecting surface or ideal diffuse radiator is directly proportional to the cosine of the angle θ between the direction of the incident light and the surface normal. Lambertian light sources are a close approximation to the radiation at the electromagnetic wave sources (111). More sophisticated models have been developed to account for the change in the radiation pattern when it passes through the optical element. The resulting radiation takes on a Gaussian distribution, so a more Lambertian-Gaussian function may be a better model. However, a simple model, can use just a Lambertian, as it is less in computation, and adequate for the application in achieving real-time processing goals. The Lambertian light source method follows the cosine law, given in the following equation:

I=Iₘₐₓ cos 0 Equation 1

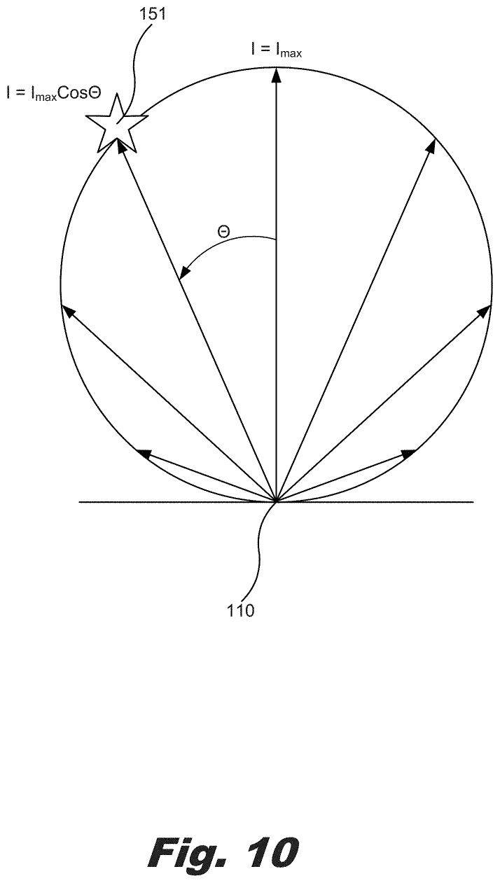

FIG. 10 is a diagram of Lambertian radiation for an electromagnetic wave source (111), according to an example of the principles described herein. The illumination of the subject (151) due to the radiation from the each of the electromagnetic wave sources (111) is measured by luminous intensity which is defined as the flux or illuminance per unit solid angle in a given direction from an electromagnetic wave source (111) or the radiant energy in the case of IR electromagnetic wave sources. Thus, in Equation 1, “I” is the luminous intensity illuminating the subject (151) situated at an angle Θ with respect to source. “Iₘₐₓ” is the luminous intensity if the target were directly in front of the electromagnetic wave source (111) along its normal.

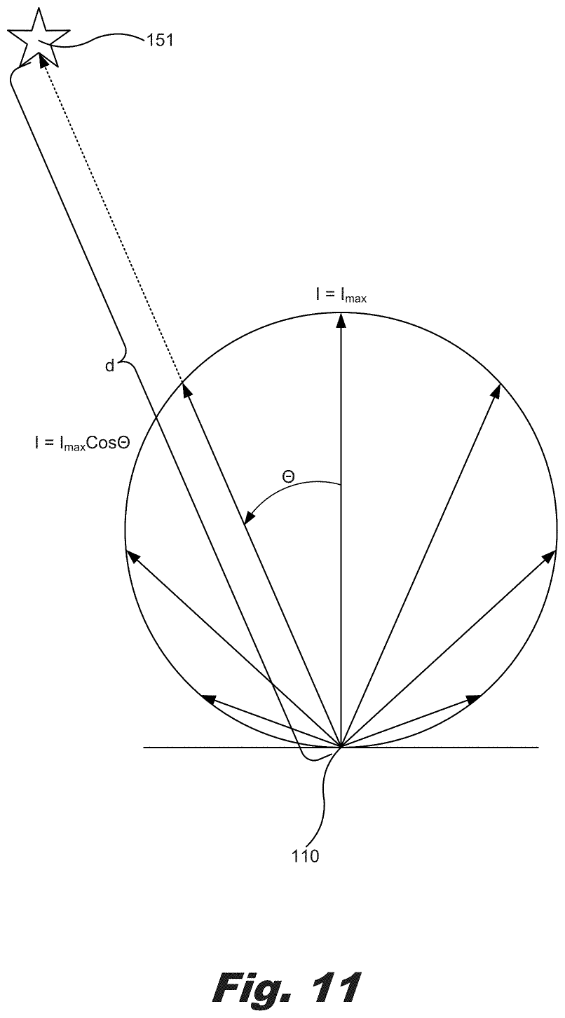

FIG. 11 is a diagram of Lambertian radiation for an electromagnetic wave source (151) at distance “d” and direction “θ, according to an example of the principles described herein. Thus, in addition to variation with respect to angle “θ,” the illumination is a function of the distance “d” of the subject (151) from the electromagnetic wave source (111), and is governed by the inverse square law. For a target distance “d” away and at an angle “θ” from the normal, the irradiance on the surface of the subject (151) is given by the following equation:

$$I = ( \frac{1}{{d}^{2}} ) {I}_{max} cos θ \qquad Equation 2$$

The electromagnetic wave sources (111) may be designed for specific view angles, ranging from, for example, a narrow 10° to more than 120°. While the radiation pattern within the view angle may be estimated by the Equations 1 and 2, the illumination drops to zero outside the view angle. Thus, the illumination values may be corrected for a view angle of the electromagnetic wave source (111). An electromagnetic wave source (111) view angle may be specified by the manufacturer in terms of the half angle, i.e. the angle at which the luminous intensity drops to half the peak value.

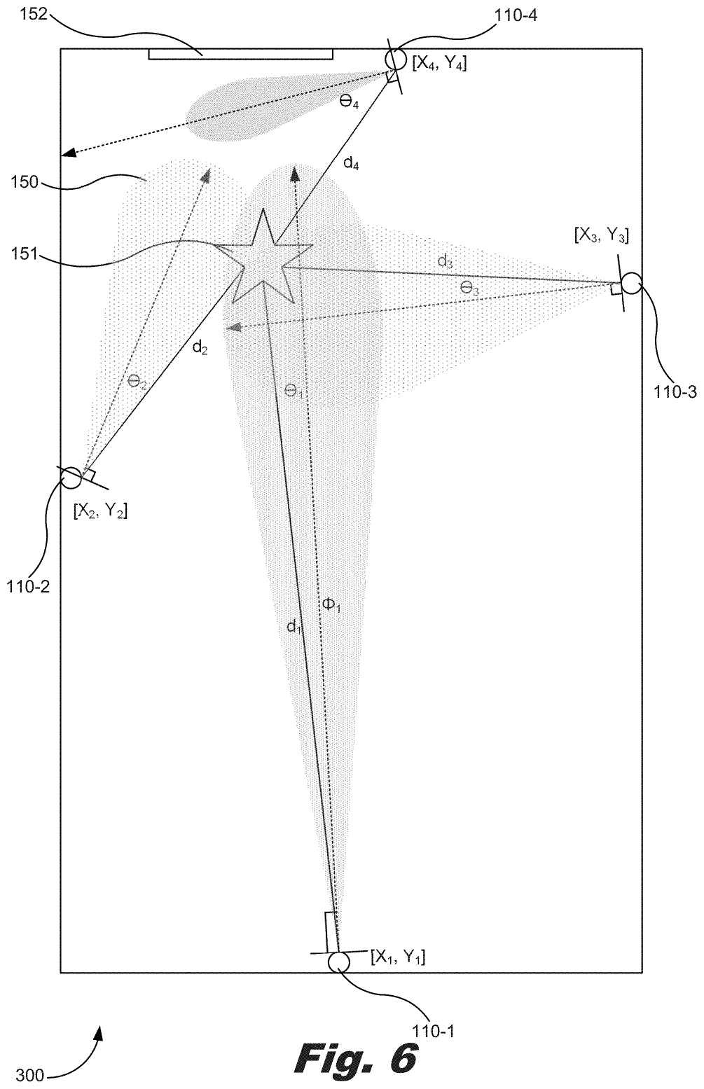

FIG. 6 is a diagram of a surveillance environment (300) including a depiction of the illumination of the electromagnetic wave sources (111) of the image capture devices (110), according to an example of the principles described herein. In FIG. 6, the incident illumination from each electromagnetic wave source (111) is represented by the Equation 2. The resultant illumination when the subject (151) is illuminated from multiple electromagnetic wave sources (111) is the sum of illumination from all electromagnetic wave sources (111). Equation 3 defines luminous intensity from the four light sources shown in FIGS. 3 through 6. Illumination from an electromagnetic wave source (111) is 0 if the subject lies outside its view angle.

$${I}_{total} = ( \frac{1}{d {1}^{2}} ) I {1}_{max} cos {θ}_{1} + ( \frac{1}{d {2}^{2}} ) I {2}_{max} cos {θ}_{2} + ( \frac{1}{d {3}^{2}} ) I {3}_{max} cos {θ}_{3} + ( \frac{1}{d {4}^{2}} ) I {4}_{max} cos {θ}_{4} \qquad Equation 3$$

Equation 3 may be extended to n number of image capture devices (110) and electromagnetic wave sources (111) as in Equation 4.

$${I}_{total} = {\sum }_{i = 0}^{n} \{ ( \frac{1}{d {i}^{2}} ) {Ii}_{max} cos {θ}_{i} , {θ}_{i} \leq 2 * α i \} 0 , \\ {θ}_{i} > 2 * α i \qquad Equation 4$$

FIG. 7 is a block diagram of an auto-exposure system (700) of a surveillance environment, according to an example of the principles described herein. The auto-exposure system (700) may include the illumination module (115) and the ISP (116) described herein. Further, the auto-exposure system (700) may include the image capture devices (110) with each image capture device (110) including an electromagnetic wave source (111). Further, in one example, each image capture device (110) may include a sensor (711). The sensor (711) may be used to detect the existence of photons of light in the space (150), detect properties of the light existent in the space (150), detect motion of any object including the subject (151) within the space (150), detect other aspects of the environment of the space (150), and combinations thereof.

In one example, images from an image capture device (110) are sent to and processed by the ISP (116). The image capture device (110) meters the illumination of the subject (151) by processing incoming frames that are then processed by the ISP (116) and global statistics data (702) about the frames are extracted. With the global statistics data (702), new camera sensor gain and integration times are determined by the illumination module (115) as global gain values (701). Further, the amplitude settings of the electromagnetic wave sources (111) are determined by the illumination module (115) as part of the global gain values (701) given the global statistics data (702). The frame from the resulting exposure is read by the illumination module (115) in order to move towards an optimum exposure value of the subject (151). This process is repeated a number of times until optimum exposure is achieved.

The auto-exposure system (700) of FIG. 7 allows this same system (i.e., the auto-exposure system (700)) to control uniformity or any other illumination balancing controls. Equation 4 herein may be repeated using a weight multiplier, Wᵢ. The equalization is achieved by solving Equation 5 below. In a real-time system, solving Equation 5 may be inefficient and may challenge real-time computation goals. Thus, in one example, ranges of irradiance curves may be pre-computed and stored in a lookup table (LUT) in the data storage device (102) for use during the real time processing:

$${I}_{total} = {\sum }_{i = 0}^{n} \{ {W}_{i} ( \frac{1}{d {i}^{2}} ) {Ii}_{max} cos {θ}_{i} , {θ}_{i} \leq 2 * α i \} 0 , \\ {θ}_{i} > 2 * α i \qquad Equation 5$$

The sensor (711) of the auto-exposure system (700) may be a passive device that is continually or intermittently searching for movement within the space (150) in order to activate the image capture devices (110) and the electromagnetic wave sources (111). Once the sensor (711) detects the presence of a subject (151) such as an individual who has entered the space (150) through the entrance (152) such as a door, the image capture devices (110) and the electromagnetic wave sources (111) may be activated in order to expose the subject (151) to an optimum level of light, and capture images of the subject (151) under those conditions.

The electromagnetic wave sources (111) may be selectively activated in order to provide the optimum exposure to the subject (151). In some examples, the electromagnetic wave sources (111) may be selectively activated to provide a uniform exposure of the subject (151) where all the electromagnetic wave sources (111) are identical and uniformly distributed around the subject (151). However, due to the non-symmetric layout of the image capture devices (110) and the electromagnetic wave sources (111) around the space (150), this uniformity may be difficult to achieve. Thus, the electromagnetic wave sources (111) may be activated and instructed by the illumination module (115) to provide different intensities of light to achieve a uniform exposure of the subject (151). In this manner, the electromagnetic wave sources (111) and their associated image capture devices (110) communicate with one another via the system (200) for exposure control of captured images and the auto-exposure system (700) to achieve a uniform exposure of the subject (151).

Because the subject (151) may move about in the space (150) after entering the space (150) through the entrance (152), the system (200) and auto-exposure system (700) may continually, send messages between and synchronize the image capture devices (110) and electromagnetic wave sources (111), establish coordinates of the subject (151) with respect to each image capture device (110) and electromagnetic wave source (111), estimate illumination of the subject (151) based on the established coordinates, and use the auto-exposure system (700) to achieve a uniform exposure of the subject (151). By repeating these processes, the system (200) and auto-exposure system (700) may continually capture images of the subject (151) as the subject (151) moves within the space (150).

The triggering or activation of the image capture devices (110) and electromagnetic wave sources (111) may be synchronized. In one example, a first electromagnetic wave source (111) may be used as a master, and the remaining electromagnetic wave sources (111) may be activated upon detection of photons from the master electromagnetic wave source (111) using their respective sensors (711) such as in a similar scenario where professional remote flash units are used in photography. In another example, all the image capture devices (110) and electromagnetic wave sources (111) may be passively “listening” to a common radio or audio signal and may activate upon reception of the radio or audio signal. In still another example, individual digital communication channels may be established with all the electromagnetic wave sources (111), and “fire” instructions may be transmitted to all the electromagnetic wave sources (111) over a very short time interval, approximating simultaneous triggering of all of the electromagnetic wave sources (111).

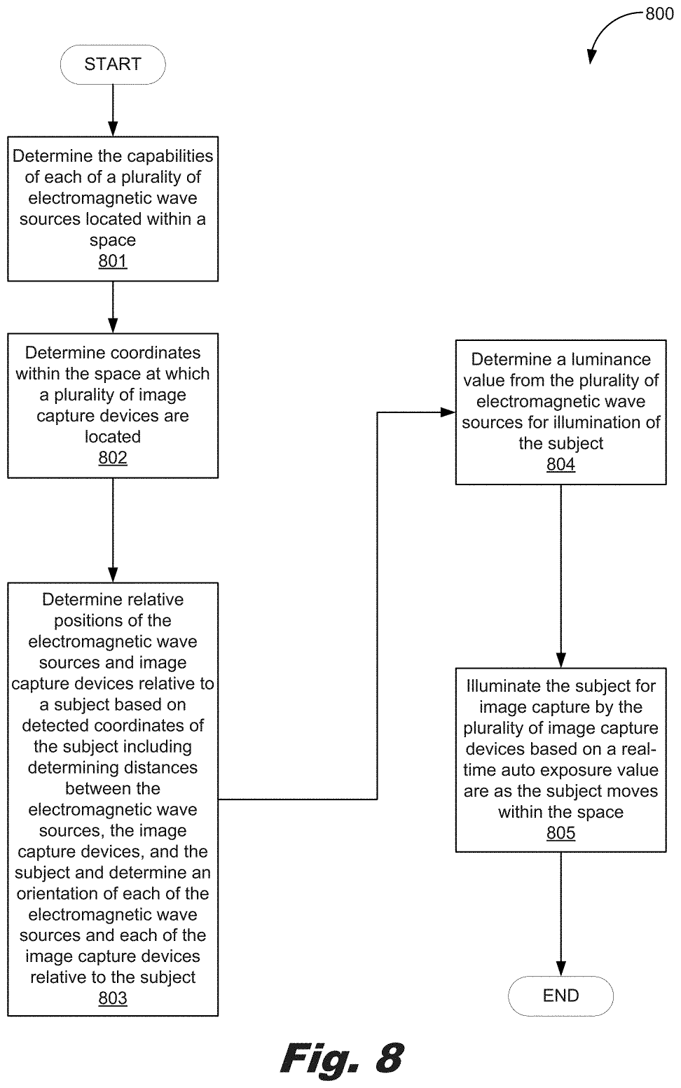

FIG. 8 is a flowchart showing a method (800) of controlling exposure of captured images, according to an example of the principles described herein. The method (800) may begin by determining (block 801) the capabilities of each of a plurality of electromagnetic wave sources (111) located within a space (150). This may be performed by the processor (101) executing the illumination module (115). The method may also include determining (block 802) coordinates within the space (150) at which a plurality of image capture devices (110) and/or their respective electromagnetic wave sources (111) are located.

The method (800) may also include determining (block 803) positions of the electromagnetic wave sources (111) and image capture devices relative to a subject (151) based on detected coordinates of the subject (151). the process at block 803 may include determining distances between the electromagnetic wave sources (111), the image capture devices (110), and the subject (151), and determining an orientation of each of the electromagnetic wave sources (111) and each of the image capture devices (110) relative to the subject (151).

The method may also include determining (block 804) a luminance value or radiant energy value from the plurality of electromagnetic wave sources (111) for illumination of the subject (151), and illuminating (block 805) the subject (151) for image capture by the plurality of image capture devices (110) based on a real-time auto-exposure value as the subject (151) moves within the space (150). The illumination module (115) may be executed by the processor (101) to achieve these processes.

Determining (block 803) relative distances between the subject (151) and each of the electromagnetic wave sources (111) may include determining an angle of the subject (151) with respect to each surface normal (301) of each electromagnetic wave source (111). The method may further include synchronizing communications between the image capture devices (110) and the electromagnetic wave sources (111) in order to provide triggering of the system to activate. The method may also include triggering the plurality of electromagnetic wave sources.

Determining the luminance value or radiant energy value may include calculating a plurality of irradiance curves, and storing the plurality of irradiance curves in a look up table. The luminance value or radiant energy value from the plurality of electromagnetic wave sources may be based on an angle of illumination of each of the plurality of electromagnetic wave sources.

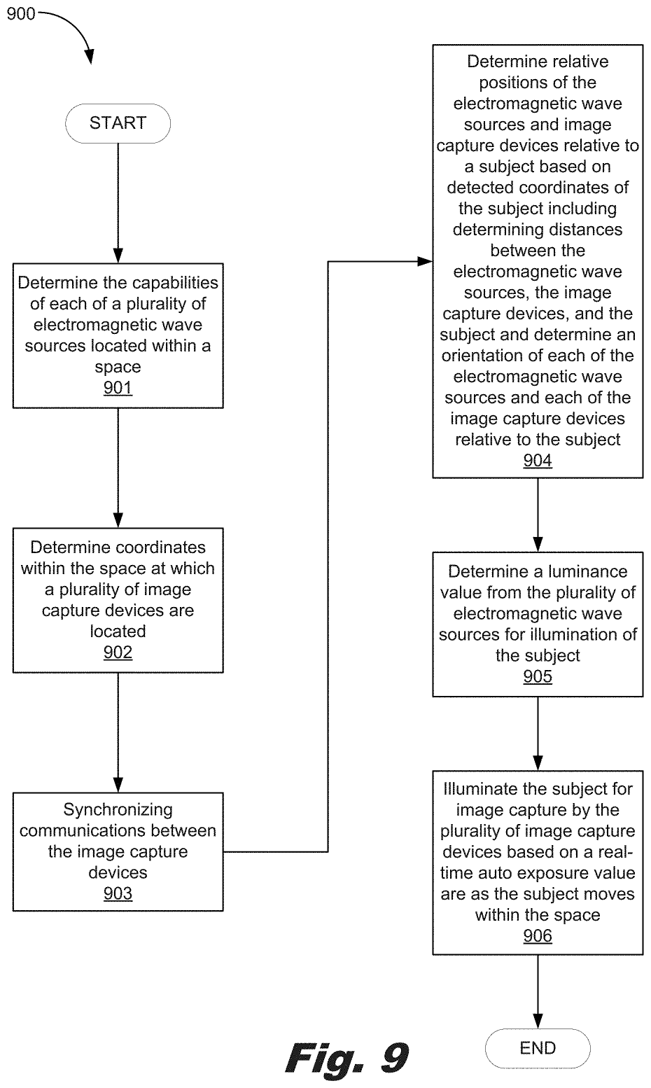

FIG. 9 is a flowchart showing a method (900) of controlling exposure of captured images, according to an example of the principles described herein. The method (900) may include determining (block 901) the capabilities of each of a plurality of electromagnetic wave sources (111) and image capture devices (110) located within a space (150), and determining (block 902) coordinates within the space (150) at which a plurality of image capture devices (110) and electromagnetic wave sources (111) are located. The method (900) may include synchronizing (block 903) communications between the image capture devices (110) and electromagnetic wave sources (111).

The method (900) may include determining (block 904) positions of the electromagnetic wave sources (111) and image capture devices (110) relative to a subject (151) based on detected coordinates of the subject (151). The method (900) may also include determining (block 905) a luminance value or radiant energy value from the plurality of electromagnetic wave sources (111) for illumination of the subject (151) based on an angle of illumination of each of the plurality of electromagnetic wave sources (111). The subject (151) may be illuminated (block 906) for image capture by the plurality of image capture devices (110) based on a real-time auto exposure value as the subject (151) moves within the space (150).

Determining (block 904) positions of the electromagnetic wave sources (111) and image capture devices (110) relative to a subject based on detected coordinates of the subject may include determining distances between the electromagnetic wave sources (111), the image capture devices (110), and the subject (151), and determine an orientation of each of the electromagnetic wave sources (111) and each of the image capture devices (110) relative to the subject (151). Determining relative distances between the subject (151) and each of the electromagnetic wave sources (111) may include determining an angle of the subject (151) with respect to each surface normal (301) of each electromagnetic wave source (111).

The method (900) may also include activating the electromagnetic wave sources (111) differently in response to detection of the subject (151) moving within the space (150). Further, determining (block 905) the luminance value or radiant energy value may include calculating a plurality of range of irradiance curves and storing the plurality of range of irradiance curves in a look up table. The method may also include triggering the plurality of electromagnetic wave sources (111) to obtain an auto exposure of the subject (151) using the auto-exposure system (700).

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processor (101) of the system (200) for exposure control of captured images or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a system for exposure control of captured images. The system may include a processor, a memory device communicatively coupled to the processor, a first image capture device located within a space and communicatively coupled to the processor, a second image capture device located within the space and communicatively coupled to the processor, a plurality of electromagnetic wave sources located within the space, and an illumination module stored on the memory device and executable by the processor. The illumination module activates the first image capture device to capture an image of a subject, and coordinate the plurality of electromagnetic wave sources to illuminate the subject based on the location of the first image capture device relative to the subject and the location and an orientation of each of the electromagnetic wave sources.

The systems and methods described herein uses multiple image capture devices and electromagnetic wave sources instead of just one without manual configuration and adjustment for each frame capturing the subject or scene. The systems and methods described herein improve illumination without the use of additional hardware, meters the exposure of the subject locally and applies settings for a globally optimum exposure. Modifications may be easily made to the image capture devices, the ISP, and auto-exposure system to support global illumination. The systems and methods estimate target illumination and provide equalization control over illumination.

The preceding description has been presented to illustrate and describe examples of the principles described. This description is not intended to be exhaustive or to limit these principles to any precise form disclosed. Many modifications and variations are possible in light of the above teaching.

What is claimed is:

1. A system for exposure control of captured images, comprising:
a processor;
a memory device communicatively coupled to the processor;
a first image capture device located within a space and communicatively coupled to the processor;
a second image capture device located within the space and communicatively coupled to the processor;
a plurality of electromagnetic wave sources located within the space;
an illumination module stored on the memory device and executable by the processor to:
activate the first image capture device to capture an image of a subject; and
coordinate the plurality of electromagnetic wave sources to illuminate the subject based on the location of the first image capture device relative to the subject and the location and an orientation of each of the electromagnetic wave sources.

2. The system of claim 1, wherein the illumination module activates the plurality of electromagnetic wave sources differently in response to detection of the subject moving within the space.

3. The system of claim 1, wherein the illumination module activates a second image capture device of the plurality of image capture devices in response to detection of the subject moving within the space.

4. The system of claim 1, wherein each of the image capturing devices are paired with one of the electromagnetic wave sources such that each image capturing device and electromagnetic wave source are integrated as the same device.

5. A method of controlling exposure of captured images, comprising:
determining the capabilities of each of a plurality of electromagnetic wave sources located within a space;
determining coordinates within the space at which a plurality of image capture devices are located;
determining positions of the electromagnetic wave sources and image capture devices relative to a subject based on detected coordinates of the subject comprising:
determining distances between the electromagnetic wave sources, the image capture devices, and the subject; and
determining an orientation of each of the electromagnetic wave sources and each of the image capture devices relative to the subject;
determining a radiant energy value from the plurality of electromagnetic wave sources for illumination of the subject; and
illuminating the subject for image capture by the plurality of image capture devices based on a real-time auto exposure value as the subject moves within the space.

6. The method of claim 5, wherein determining relative distances between the subject and each of the electromagnetic wave sources comprises determining an angle of the subject with respect to each surface normal of each electromagnetic wave source.

7. The method of claim 5, further comprising synchronizing communications between the image capture devices.

8. The method of claim 5, wherein determining the radiant energy value comprises:
calculating a plurality of irradiance curves; and
storing the plurality of irradiance curves in a look up table.

9. The method of claim 5, further comprising triggering the plurality of electromagnetic wave sources.

10. The method of claim 5, wherein the radiant energy value from the plurality of electromagnetic wave sources is based on an angle of illumination of each of the plurality of electromagnetic wave sources.

11. A computer program product for controlling exposure of captured images, the computer program product comprising:
a computer readable storage medium comprising computer usable program code embodied therewith, the computer usable program code to, when executed by a processor:
determine the capabilities of each of a plurality of electromagnetic wave sources located within a space;
determine coordinates within the space at which a plurality of image capture devices are located;
synchronize communications between the image capture devices;
determine positions of the electromagnetic wave sources and image capture devices relative to a subject based on detected coordinates of the subject;
determine a radiant energy value from the plurality of electromagnetic wave sources for illumination of the subject based on an angle of illumination of each of the plurality of electromagnetic wave sources; and
illuminate the subject for image capture by the plurality of image capture devices based on a real-time auto exposure value as the subject moves within the space.

12. The computer program product of claim 11, wherein:
determining positions of the electromagnetic wave sources and image capture devices relative to a subject based on detected coordinates of the subject comprises:
determining distances between the electromagnetic wave sources, the image capture devices, and the subject;
determining an orientation of each of the electromagnetic wave sources and each of the image capture devices relative to the subject; and
determining relative distances between the subject and each of the electromagnetic wave sources comprises determining an angle of the subject with respect to each surface normal of each electromagnetic wave source.

13. The computer program product of claim 11, further comprising computer usable program code to, when executed by a processor, activate the electromagnetic wave sources differently in response to detection of the subject moving within the space.

14. The computer program product of claim 11, wherein determining the radiant energy value comprises:
calculating a plurality of range of irradiance curves; and
storing the plurality of range of irradiance curves in a look up table.

15. The computer program product of claim 11, further comprising computer usable program code to, when executed by a processor, trigger the plurality of electromagnetic wave sources to obtain an auto exposure of the subject using an auto-exposure system.
